(19) United States
(12) Patent Application Publication
(10) Pub. No.: US 2015/0035876 A1
(43) Pub. Date: Feb. 5, 2015

(54) INDEPENDENT COLOR STRETCH IN COLOR-SEQUENTIAL DISPLAYS

(71) Applicant: Brass Roots Technologies, LLC, Plano, TX (US)

(72) Inventor: Bradley William Walker, Dallas, TX (US)

(21) Appl. No.: 14/446,410

(22) Filed: Jul. 30, 2014

Related U.S. Application Data
(60) Provisional application No. 61/862,123, filed on Aug. 5, 2013.

(51) Int. Cl. G09G 5/04

(52) U.S. Cl. CPC G09G 5/04; G09G 2320/0233; G09G 2320/0242; G09G 2320/0666
USPC 345/691

(57) ABSTRACT

Independent color stretch is an improved method for “stretching” the color sequence utilized in color-sequential displays using switchable light sources, such as LED or Laser, to match the frame rate of the video source. It utilizes a stretch factor that is directly proportional to the sequence duration to simplify the calculation of stretch factors and allow them to be combined. Independent color stretch also provides independent stretch factors for each color and allows real-time adjustment of the duty cycle of each color.

### BACKGROUND

This application claims priority to U.S. Provisional Patent Application Ser. No. 61/862,123, filed Aug. 5, 2013, entitled “Independent Color Stretch in Color-Sequential Displays,” the entire content of which is hereby incorporated by reference.

The present disclosure pertains generally to color-sequential displays that use switchable light sources and methods for adjusting the timing of the color sequence and duty cycle for each color. In particular, this disclosure pertains to the use of independent color stretch, which allows for independent stretch factors for each color and real-time adjustment of the duty cycle for each color.

In color-sequential displays that use switchable light sources (e.g. LED or Laser) the timing of the color sequence is determined by a processor called the sequencer. The sequencer runs a program (the “sequence”) that controls the timing of operations in the display. Traditionally, the sequencer has had the ability to stretch the sequence in time as required to match the frame rate of the video source. This is particularly important in arrays of displays, where the displays must be matched not only in terms of color balance, but absolute light levels as well. In an array of displays, the weakest channel of the weakest display limits the maximum light level of all the colors of all the displays for a given color balance, i.e. white point.

Existing methods of stretching the sequence use a technique called “clock dropping.” (See U.S. Pat. No. 7,019,881 and U.S. Pat. No. 5,912,712, incorporated herein by reference). “Clock dropping” involves calculating the extension factor needed to stretch the sequence, then utilizing a counter to repetitively count down a number of clock cycles and cause the clock to drop a cycle. The dropping of clock cycles effectively expands the sequence time, as it takes longer to reach the necessary number of clock cycles that determine a sequence. These existing “clock dropping” methods result in an inverse relationship between the clock drop factor and the sequence duration.

### SUMMARY

An improvement to previous methods used to stretch a sequence is the use of independent color stretch. Independent color stretch provides the ability to have independent stretch factors for each color. This provides real-time adjustment of the duty cycle of each color. The ability to adjust the duty cycles of the colors is important, as it adjusts the color balance of the display, while maintaining maximum light output capability. (See U.S. Patent Publication No. 2008/0084369, incorporated herein by reference).

Unlike “clock dropping,” independent color stretch uses a stretch factor that is directly proportional to the sequence duration, i.e. each change by 1 LSB adds the same amount of time to the color segment or sequence. For example, certain embodiments use a fixed-point stretch factor ranging from 1.0 up to a number just less than a power of two, typically 2.0-1 LSB. This makes the calculation of stretch factors much simpler and allows multiple stretch factors to be combined or concatenated or functionally composed by a simple multiplication. For example, in an RGB system, there may be stretch factors for each of R, G, and B, as well as an overall, or Master stretch factor. By multiplying the RGB stretch factors by the Master stretch factor and then applying the results to the sequence, one can adjust the overall stretch, as well as independently adjust the ratios of the colors.

A preferred example of a stretch circuit used to implement the independent color stretch method executes extra no-operation instructions, or NOPs at a particular duty cycle. Strictly speaking, clock dropping only applies to sequencers that execute 1 instruction per clock. The technique of inserting NOP instructions works with sequencers that take 1 or multiple clock cycles to execute an instruction.

Further, the use of independent color stretch allows for the application of no stretch to dark time. When switching from one color to another, common practice is to have a transition region of time (typically 5 to 10 us) where the display is forced to black. This transition region is termed “dark time”. The use of dark time avoids image disturbances while the light source colors are switching. In order to maximize the light output capability of the display, the stretch factor during dark time should be set to the minimum amount. This results in the duration of the dark time staying constant, even as the various colors are stretched by independent amounts. Dark time can also exist for other reasons, such as loading the display device with data, techniques for making smaller bits of light, and various overheads required or used by the particular display technology. In each case, applying minimum stretch (i.e. zero stretch, or stretchFactor=1.0) may be beneficial in terms of total light output or efficiency.

The present independent color stretch method also calculates and implements delays to compensate for advanced light source strobe signal shift. The switchable light source typically needs advance notice of a color or mode change, typically on the order of 10 to 60 us. This may be implemented in the form of a strobe signal that is advanced in time relative to the desired Light Source transition point. In independent color stretch, the strobe signals instructing the light source to switch colors must be issued during a prior color segment, which will normally use a stretch factor that is not unity. This causes the advanced strobe signal to shift in time, in accordance with said prior color segment's stretch factor. Delaying the advanced strobe signal by a calculated amount compensates for this shift. When the transition is dark time, the advance correction will be a constant because the dark time stretch factor is 1.0, or unity.

All of the improvements that result from the use of independent color stretch can be applied to 3-chip systems (non-color-sequential) or systems that combine color-sequential and color-per-chip attributes.

### BRIEF DESCRIPTION OF DRAWINGS

FIG. 1 shows an example of an embodiment of a stretch circuit for use in implementing independent color stretch;

FIG. 2 shows a schematic representation of an example of an advanced strobe signal with no stretch;

FIG. 3 shows a schematic representation of examples of strobe advance in which stretch varies by color segment;

FIG. 4 shows a schematic representation of strobe advance with no stretch and a long advance; and

FIG. 5 shows a schematic representation of strobe advance where the stretch varies and a long advance is necessary.

### DETAILED DESCRIPTION OF PREFERRED EMBODIMENTS

The implementations of independent color stretch applied to color-sequential displays described herein demonstrate multiple improvements compared to previous methods for color sequence stretching.

One improvement is the utilization of a stretch factor that is directly proportional to the sequence duration. Each change by 1 LSB adds the same amount of time to the color segment or sequence. A preferred embodiment uses a fixed-point stretch factor that ranges from 1.0 (unity) up to a number just less than a power of two, typically 2.0-1 LSB. For example, for a 16-bit stretch factor representing a range of [1.0, 2.0) with an implied 17^{th} bit with a value of one is encoded as shown below in Table 1.

TABLE 1
Stretch Factor vs. Hex Value

| Stretch Factor | Hex Value |
|---|---|
| 1.0 | 0x10000 |
| 1.2 | 0x13333 |
| 1.5 | 0x18000 |
| 1.75 | 0x1C000 |
| 1.99998 | 0x1FFFF |

The use of a directly proportional stretch factor allows combining or concatenating multiple stretch factors. For example, in an RGB system, there may be stretch factors for each of R, G, and B, as well as an overall, or Master stretch factor. By multiplying the RGB stretch factors by the Master stretch factor and then applying the results to the sequence, one can adjust the overall stretch, as well as independently adjust the ratios of the colors. For example, if the range of the stretch factor is [1.0, 2.0), then the combination of two factors would have a range of [1.0, 4.0).

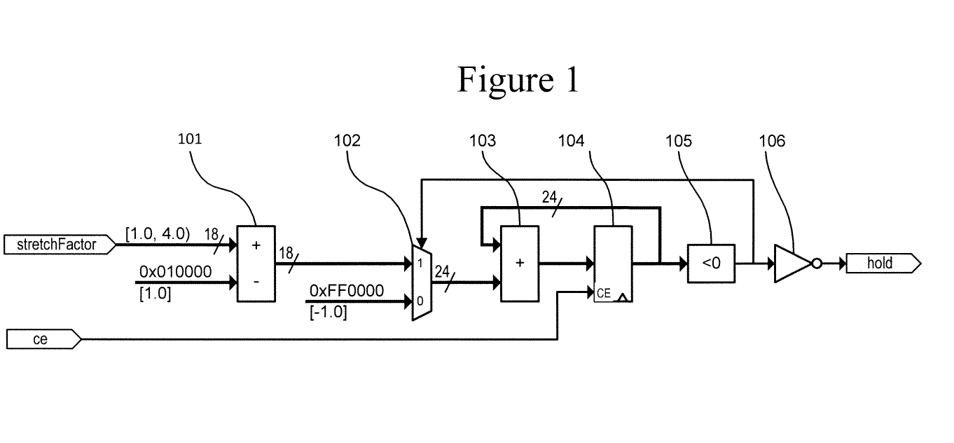

FIG. 1 shows a preferred embodiment of a stretch circuit for an implementation of independent color stretch in a color-sequential display. The stretch circuit includes an input subtractor 101, increment selector 102, adder 103, accumulator register 104, comparator 105, and inverter 106. An 18-bit stretch factor is presented to the input subtractor 101. The stretch factor can represent a range of [0.0, 4.0), but only the range [1.0, 4.0) is used. The input subtractor 101 subtracts the equivalent of 1.0 from the input stretch factor. Depending on the output of the comparator 105, the increment selector 102 selects either the output of the input subtractor 101 or the equivalent of minus 1 (−1.0). The adder 103 sums the output of the increment selector with the value in the accumulator register 104. All values are two's complement. The register accumulator 104 holds a 24-bit value that represents a range of [−128, 128).

When the register accumulator value is negative, said value will be incremented by the input stretch factor, minus 1.0 (i.e. stretchFactor−0x010000). When the register accumulator value is zero or greater, said value will be decremented by 1.0 (i.e. 0xFF0000). The combination of these actions results in the output of comparator 105 pulsing HIGH with a duty cycle inversely proportional to the stretchFactor. The output of inverter 106 will therefore pulse HIGH with a duty cycle of (1.0−1/stretchFactor). If the stretchFactor is 1.0, then the inverter 160 output signal will always be HIGH and the hold signal will always be LOW.

A sequencer is a processor that executes instructions at a fixed rate and directs the operation of a system or subsystem. As the instructions all take the same amount of time, a timeline of operations can be encoded in the instruction stream, with the unit of time equal to one instruction. Hold signal 106 is used to signal the sequencer that it should insert and execute an extra NOP, or no-operation instruction. By executing extra NOPs at a duty cycle of (1.0−1.0/stretchFactor), the length of the resulting instruction stream will be proportional to stretchFactor, but can never be shorter than 1.0 times the original instruction stream. Because clock dropping typically only applies to sequencers that execute 1 instruction per clock, it is not compatible with sequencers having multiple clocks per instruction. The technique of inserting NOP instructions utilized with independent color stretch works with sequencers that take 1 or multiple clock cycles to execute an instruction.

In one example, if the stretchFactor is 1.5 then hold signal 106 will pulse High with a duty cycle of 0.33=(1.0−1/1.5). Execution of the instruction stream will take 1.5 times as long as without stretching. In another example, if the stretchFactor is 2.0 then hold signal 106 will pulse High with a duty cycle of 0.50=(1.0−1/2.0). Execution of the instruction stream will take 2.0 times as long as without stretching.

The use of independent color stretch also has the advantage of applying no stretch to “dark time,” which is the transition region of time (typically 5 to 10 us) when the display may be forced to black while switching from one color to another. Maximizing the light output capability of the display requires that the stretch factor during dark time should be set to the minimum amount. Independent color stretch applies minimum stretch (i.e. zero stretch, or stretchFactor=1.0), which is beneficial in terms of total light output or efficiency.

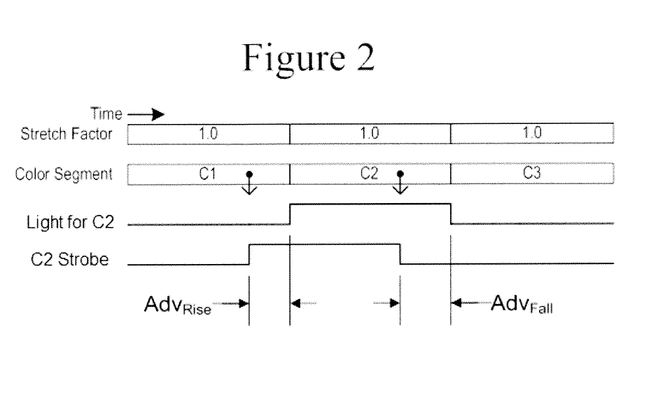

The independent color stretch method described herein also implements delays in light source strobe signal in order to compensate for signal shift. The switchable light source typically needs advance notice of a color or mode change, usually on the order of 10 to 60 us. This may be implemented in the form of a strobe signal that is advanced in time relative to the desired light source transition point. The desired strobe advance is usually a fixed amount, but may also be dependent on the drive level of the light source, or other factors. FIG. 2 shows an example of this advanced strobe signal, in the simple case of no stretch. The advance required may be different for rising edges versus falling edges.

In FIG. 2, the arrows pointing down from the C1 and C2 segments indicate the location in time of the sequencer instructions that cause the C2 Strobe to change signal level. The beginning of the strobe for color segment C2 needs to be advanced by Adv_{Rise}, so an instruction is executed by the sequencer Adv_{Rise} before the end of color segment C1. The end of the strobe for color segment C2 needs to be advanced by Adv_{Fall}, so an instruction is executed by the sequencer Adv_{Fall} before the end of color segment C2.

An issue with independent color stretch is that the strobe signals instructing the light source to switch colors must be issued during a prior color segment, which will normally use a stretch factor that is not unity. This causes the advanced strobe signal to shift in time, in accordance with said prior color segment's stretch factor. This shift can be compensated by delaying the advanced strobe signal by an amount that is proportional to the amount of advance occurring in the prior color segment, multiplied by the stretch factor of the prior color segment, minus the amount of advance occurring in the prior color segment:

Delay=Advance*StretchFactor−Advance

Refactored:

Delay=Advance*(StretchFactor−1.0)

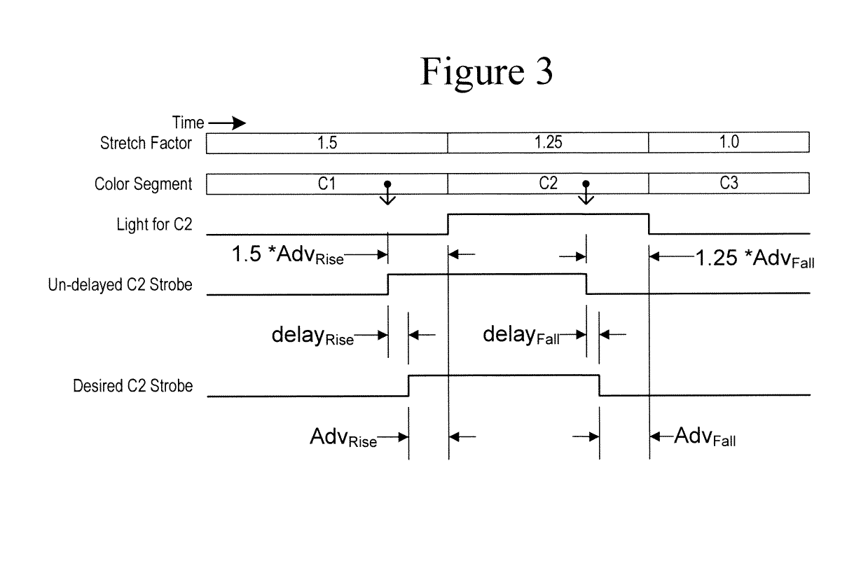

FIG. 3 shows a pair of examples. As in the previous example, the beginning of the strobe for color segment C2 needs to be advanced by Adv_{Rise}, so an instruction is executed by the sequencer Adv_{Rise} before the end of color segment C1. The end of the strobe for color segment C2 needs to be advanced by Adv_{Fall}, so an instruction is executed by the sequencer Adv_{Fall} before the end of color segment C2. However, in this example, color segment C1 is using a stretch factor of 1.5 and color segment C2 is using a stretch factor of 1.25. This means that the advanced strobe signals implemented by the sequencer instruction stream will happen earlier than desired, due to the action of the stretch function. The extra delay for the beginning and end of the strobe for C2 can be calculated as follows:

delay_{Rise}=Adv_{Rise}*(1.5−1.0)=Adv_{Rise}*0.5

delay_{Fall}=Adv_{Fall}*(1.25−1.0)=Adv_{Rise}*0.25

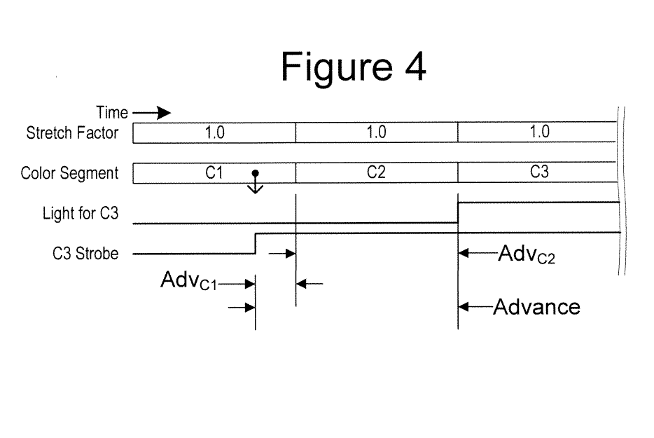

If the advance required is longer than the prior color segment, then the sequencer instruction must be placed in an earlier color segment than the immediately prior one. FIG. 4 shows an example where the strobe for color segment C3 needs to be advanced by more than the duration of color segment C2. To accomplish this, the sequencer instruction for this strobe is placed during color segment C1. Since segments C1 and C2 have unity stretch factors, no extra delay is required.

When using non-unity stretch and advance greater than the prior color segment(s), two or more corrections may be concatenated to achieve the correct delay.

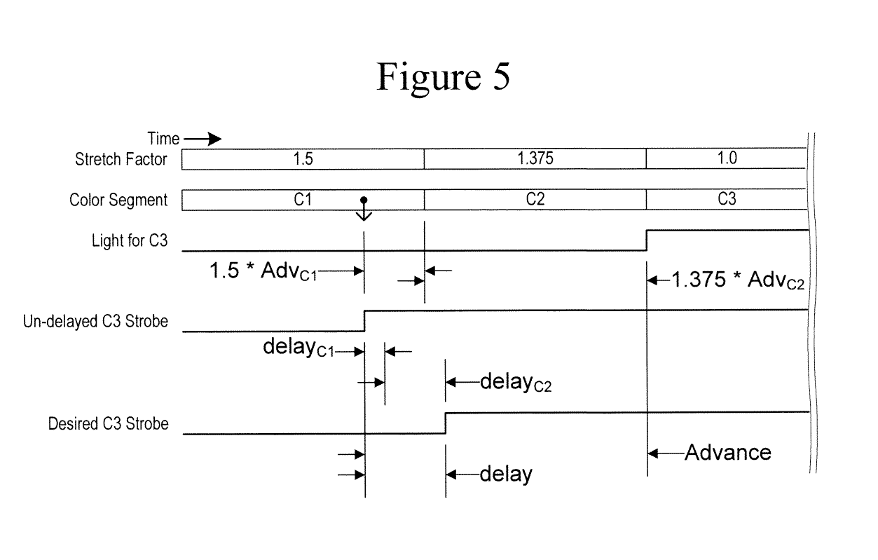

FIG. 5 shows an example where the strobe for color segment C3 needs to be advanced by more than the duration of color segment C2. To accomplish this, the sequencer instruction for this strobe is placed during color segment C1. Segments C1 and C2 have non-unity stretch factors, so extra delays must be added for C1 and C2. The delays are proportional to the amount of advance occurring in each color segment, multiplied by the stretch factor of that color segment, minus the amount of advance occurring in that color segment. The total delay is the sum of the delays for each segment from the time of the advanced strobe until the start of the color segment associated with the strobe.

As shown in FIG. 5, the beginning of the strobe for color segment C3 needs to be advanced by Advance=Adv_{C1}+Adv_{C2}, so an instruction is executed by the sequencer Adv_{C1} before the end of color segment C1. Adv_{C2}, is the length of color segment C2. In this example, color segment C1 is using a stretch factor of 1.5 and color segment C2 is using a stretch factor of 1.375. These non-unity stretch factors cause the advanced strobe signal (implemented by the sequencer instruction stream) to happen earlier than desired. The required extra delays to add to the beginning of the strobe for C3 can be calculated as follows:

delay_{C1}=Adv_{C1}*(1.5−1.0)=Adv_{C1}*0.5

delay_{C2}=Adv_{C2}*(1.35−1.0)=Adv_{C2}*0.375

delay=delay_{C1}+delay_{C2}

As already discussed, the typical practice is to have a dark time transition region before each color segment. Since the time advance for the color change (typically 10 to 60 us) is typically longer than the transition region (typically 5 to 10 us), there may need to be two advance corrections: one for the time in the prior color and another during the transition region. A special case occurs when the transition is dark time and the stretch for dark time is always 1.0. In this case the advance correction will be the correction for the prior color segment plus the length of the transition region (a constant). Thus it is not necessary to do the multiplication by the dark time stretch factor minus one, as it is unity.

Overall, the independent color stretch method described herein provides multiple improvements over prior systems. The sequence length is directly proportional to the stretch factor. Each stretch factor increase of 1 LSB causes the same additional length to be added to sequence or color segment time. A combination of stretch factors by multiplication is possible. Independent color stretch also uses fixed-point representation with an implied leading ‘1’ MSB. The stretch circuit design, of which an example is shown in FIG. 1, represents an improvement over prior systems. NOP insertion, unlike clock dropping, works with processors that use multiple clocks per instruction, in addition to processors that use 1 clock per instruction. Dark time has no stretch applied. In addition, the method utilizes constant advance strobes, due to delay compensation for non-unity stretch factor(s). Cascaded delay compensation is also provided for constant advance longer than the prior color segment. The compensation delay is equal to Advance*(StretchFactor−1.0). Finally, dark transition uses a unity stretch factor so that compensation delay is a constant.

What is claimed is:

1. A method for implementing independent color stretch in color-sequential displays using a sequencer to control color sequence and timing, comprising:
determining a stretch factor for each color in the color sequence, wherein each stretch factor is directly proportional to duration of said color in the sequence;
encoding a timeline of operations into an instruction stream for the sequencer;
inputting each stretch factor into a stretch circuit in communication with the sequencer, wherein the stretch circuit uses the stretch factors to produce a hold signal;
using the hold signal to signal the sequencer to insert and execute no-operation instructions (NOPs) in the instruction stream at a duty cycle dependent on the stretch factors; and
operating the sequencer in accordance with the instruction stream to control color sequence and timing.

2. The method of claim 1, wherein the stretch factors range from 1.0 to less than a power of 2.0.

3. The method of claim 1, wherein the duty cycle is calculated as 1.0-1.0/stretch factor.

4. The method of claim 1, wherein the stretch factor for dark time is 1.0.

5. The method of claim 1, further comprising the step of multiplying the stretch factor for each color by a master stretch factor, whereby the stretch factor for each color is adjusted proportionally.

6. The method of claim 1, further comprising the step of using the stretch circuit to calculate delays in strobe signals used to direct a light source of the color-sequential displays to switch colors, wherein the delays compensate for shifts in the strobe signals caused by instructions directing the light source to switch colors during a prior color segment using a stretch factor that is not 1.0.

7. The method of claim 6, wherein more than one delay is calculated for a single strobe signal to compensate for shifts occurring during multiple prior color segments.
